(19) United States
(12) Patent Application Publication
(10) Pub. No.: US 2020/0215521 A1
(43) Pub. Date: Jul. 9, 2020

(54) METHOD FOR PRODUCING METAL-CONTAINING CATALYSTS

(71) Applicant: ExxonMobil Research and Engineering Company, Annandale, NJ (US)

(72) Inventors: Wenyih Frank Lai, Bridgewater, NJ (US); Paul Podsiadlo, Humble, TX (US); Chuansheng Bai, Phillipsburg, NJ (US); William W. Lonergan, Humble, TX (US); Louis F. Burns, Spring, TX (US); Stephen J. McCarthy, Center Valley, PA (US); Nicholas S. Rollman, Hamburg, PA (US)

(21) Appl. No.: 16/637,892

(22) PCT Filed: Aug. 30, 2018
(86) PCT No.: PCT/US2018/048684

§ 371 Date: Feb. 10, 2020

Related U.S. Application Data
(60) Provisional application No. 62/558,893, filed on Sep. 15, 2017.

(51) Int. Cl. B01J 29/78; B01J 37/04; B01J 37/00; B01J 37/08; B01J 37/02; B01J 21/04; C10G 45/12

(52) U.S. Cl. CPC B01J 29/7861; B01J 2229/38; B01J 37/0018; B01J 37/088; B01J 37/0209; B01J 29/7876; B01J 21/04; C10G 45/12; C10G 2300/202; C10G 2300/308; C10G 2300/304; C10G 2300/301; C10G 2300/1055; C10G 2400/04; B01J 37/04

(57) ABSTRACT

A method for making catalyst materials is disclosed in which active metal ingredients of the final catalyst are added to a mixture for extruding the catalyst material that includes a binder, one or more precursors of one or more base metals and/or one or more noble metals, and a crystal of a zeolite. The extruded catalyst material is then pre-calcined and ion-exchanged and then a final calcining step is applied. The catalyst materials made by such a method are also disclosed as is a method for treating a hydrocarbon stream using the catalysts.

### FIELD

The present application relates to methods for preparing metal-containing catalysts, to the catalysts so prepared and to methods for using the catalysts.

### BACKGROUND

Many petrochemical processes make use of catalysts. For example, removal of sulfur compounds and dewaxing requires isomerization activity of molecular sieves and hydrodesulfurization/hydrodeamination (HDS/HDN) utilizes the chemistry of elemental metals. Achieving a high level of HDS/HDN activity typically requires large concentrations of elemental metals (Co/Mo, Ni/Mo, or Ni/W), i.e. several wt. %. The elemental metals are typically applied using incipient wetness impregnation onto molecular sieve/binder extrudates.

Also, many commercial catalysts contain large pore volume and large surface area active materials or supports. For some applications, these materials may require impregnation of catalytically active metals after the support has been prepared, e.g. after extrusion.

A typical impregnation process calls for preparing a solution of salts of the desired metals and applying the solution onto a support, for example, by spraying, then drying of support for water removal, and calcination to decompose metals salts and to form active metals centers. These impregnation steps add additional cost and processing time in the manufacturing scheme.

Achieving good metals dispersion at high metals concentrations is challenging and may lead to extrudate pore blocking and metals agglomeration/maldistribution. Pore blocking can decrease effectiveness of a zeolite, while metals agglomeration can reduce hydrotreatment (HDT) effectiveness. So, achieving good performance requires optimization of the starting elemental extrusion with large enough pore sizes, which upon impregnation with elemental metals won't become fully blocked. While feasible, the increased porosity can also lead to decreased mechanical integrity.

Furthermore, the large pore volume in these catalysts may require extra precautions and optimization of the drying process, in order to carefully remove the water absorbed during impregnation. The impregnation typically calls for spraying the metal-containing solution up to the extrudate saturation level in order to distribute the metals as uniformly as possible throughout the extrudate, which for highly porous supports, can result in large water uptake. In order to prevent poor distribution of metals, the drying process has to be optimized in terms of drying rates. Inaccurate calculation of impregnation solution volumes or non-optimum drying rates can lead to maldistribution of the active metals and underperformance of the finished catalyst.

### SUMMARY

A method for preparing catalyst materials having an improved distribution of elemental metals throughout the cross-section of the catalyst material, with resulting improvement in catalyst performance, is disclosed.

Thus, one aspect of the presently disclosed method is a method for producing a catalyst material, comprising:
mixing a binder, a porous crystalline material, water, and one or more precursors of base metal Ni or Co or a mixture of both, to form an extrudable paste;
extruding the paste to form a green catalyst extrudate; and
pre-calcining the green catalyst extrudate to form a pre-calcined extrudate;
ion-exchanging the pre-calcined extrudate to obtain an ion-exchanged extrudate; and
calcining the ion-exchanged extrudate to obtain a catalyst material.

The mixing step can further comprise one or more precursors of one or more base metals W or Mo, or a mixture of both. The mixing step can yet further comprise one or more precursors of one or more noble metals Pt or Pd, or a mixture of both.

### BRIEF DESCRIPTION OF THE FIGURES

FIGS. 1A and 1B are photos respectively of green extrudates and finished extrudates prepared according to Example 2 and having 1 wt. % Ni and 5 wt. % W.

FIG. 2 is a photo of finished catalyst prepared in Example 3 and having 2 wt. % Ni and 10 wt. % W.

FIG. 3 is a photo of ammonium acetate exchanged catalyst having 2 wt. % Ni and 6 wt. % Mo prepared in Example 5A.

FIG. 4 is a photo of ammonium nitrate exchanged catalyst having 2 wt. % Ni and 6 wt. % Mo prepared in Example 5B.

FIG. 5 is a photo of ammonium chloride exchanged catalyst having 1 wt. % Ni and 5 wt. % Mo prepared in Example 6.

FIG. 6 shows a comparison of HDS catalytic activity vs. days on stream (DOS) and RXR temperature of catalysts prepared by “muller metals addition” method (Examples 2-5) vs. traditional post-extrusion impregnation (Example 1).

FIG. 7 shows a comparison of HDN catalytic activity vs. days on stream (DOS) and RXR temperature of catalysts prepared by “muller metals addition” method (Examples 2-5) vs. traditional post-extrusion impregnation (Example 1).

FIG. 8 shows a comparison of dewaxing activity of catalysts prepared by “muller metals addition” method (Examples 2-5) vs. traditional post-extrusion impregnation (Example 1) on HPHT refinery feed.

FIG. 9 shows a second comparison of dewaxing activity of catalysts prepared by “muller metals addition” method (Examples 2-5) vs. traditional post-extrusion impregnation (Example 1) on HPHT refinery feed.

FIGS. 10A and 10B show respectively images of wt % Ni—K EDS map and wt % W—L EDS map for a first piece of the catalyst prepared in Example 4.

FIGS. 11A and 11B show respectively images of wt % Ni—K EDS map and wt % W—L EDS map for a second piece of the catalyst prepared in Example 4.

FIGS. 12A and 12B show respectively wt % Ni—K EDS map and wt % W—L EDS map for a third piece of the catalyst prepared in Example 4.

FIGS. 13A and 13B show respectively images of wt % Ni—K EDS map and wt % W—L EDS map for a fourth piece of the catalyst prepared in Example 4.

FIGS. 14A and 14B show respectively wt % Ni—K EDS map and wt % W—L EDS map for a fifth pellet of the catalyst prepared in Example 4.

### DETAILED DESCRIPTION

The disclosed method provides an alternate to prior routes for making high quality base metal-containing molecular sieve extrudates by eliminating the costly step of post-extrusion metals impregnation. Base metal-containing extrudates according to the present disclosure are prepared by one-step process of extruding the muller mixtures containing a porous crystalline material, binder, and metal precursors. The resulting green extrudates are pre-calcined, ion-exchanged, steamed (optional for making base metal coated catalysts), and air-calcined to produce the finished catalysts without the additional metal impregnation step. Extrusions containing different combinations and concentrations of Ni/W and Ni/Mo have been demonstrated. Ion-exchanging of pre-calcined extrudates was evaluated using ammonium nitrate, ammonium acetate, and ammonium chloride solutions. Example catalysts prepared by muller addition were not steamed, but this treatment can be applied.

The disclosed method enables reduction in metals loading, potentially increased metals dispersion, and increase in physical integrity of finished catalysts. All of these can lead to reduced production costs, increased performance (HDT and dewaxing), and increased value proposition for customers.

Sour service dewaxing requires isomerization activity of a molecular sieve and HDS/HDN function of base metals. Achieving high level of HDS/HDN activity typically requires large concentrations of base metals (Co/Mo, Ni/Mo, or Ni/W), i.e. several wt. %. The base metals are typically applied using incipient wetness impregnation onto zeolite/binder extrudates. Achieving good metals dispersion at high metals concentrations is challenging and may lead to extrudate pore blocking and metals agglomeration/maldistribution. Pore blocking can decrease effectiveness of the molecular sieve, while metals agglomeration can reduce HDT effectiveness. So, avoiding pore blocking so as to minimize this detriment to overall catalyst performance requires optimization of the starting base extrusion with large enough pore sizes, which upon impregnation with base metals won't become fully blocked. While feasible, the increased porosity can also lead to decreased mechanical integrity.

An alternative method for preparing sour service dewaxing catalysts with improved physical and catalytic properties, as well as potentially lower production cost, is disclosed. The disclosed method includes mixing the base metals salts precursors together with a molecular sieve, binder, and water, prior to extrusion (“the muller addition”). This procedure eliminates additional steps associated with post-extrusion metals impregnation which reduces manufacturing time and additional processing costs.

In one embodiment, the method of the present disclosure has been applied to preparing sour service dewaxing catalysts incorporating ZSM-48 zeolite. The catalysts were prepared with different combinations of base metals, i.e. NiW and NiMo and using a high surface area/small pore binder. Other combinations of metals and binders can be used as well. For comparison, a reference catalyst was formulated with low surface area/large pore size binder, and using the post-extrusion impregnation process.

The “muller-addition catalysts” prepared with various combinations of metals composition and concentration (including lower metals concentrations than the reference) show improvements in crush strength, decrease of fines generation (improved mechanical integrity), increased micropore surface area, improved metals dispersion, and decreased loading density. This was an unexpected and non-intuitive result.

Catalytic performance of several examples of finished catalysts were evaluated in a Tri-Phase Reactor (TPR), showing comparable HDS/HDN and dewaxing (cloud point reduction) performance compared to incipient-wetness impregnated reference. Catalysts with as low as ⅓ of the metals loading and 25% lower loading density when compared to post-extrusion impregnated catalyst showed equivalent HDS/HDN performance and cloud point reduction.

In summary, high performance, base metal-coated zeolite-based (e.g. ZSM-48-based) extrudates can be prepared by an alternate route, i.e. the muller addition, without an additional, costly post-extrusion metal impregnation process. The resulting finished catalysts showed major improvements in physical properties and catalytic performance over a post-extrusion impregnated reference catalyst.

One aspect of the present disclosure is a method for producing a catalyst material comprising:
a. mixing a binder having a surface area, a porous, crystalline material, water, and one or more precursors of base metal Ni or Co or a mixture of both, to form an extrudable paste;
b. extruding the paste to form a green catalyst extrudate; and
c. pre-calcining the green catalyst extrudate in a nitrogen atmosphere to form a pre-calcined extrudate catalyst material;
d. ion-exchanging the pre-calcined extrudate to obtain an ion-exchanged extrudate; and
e. calcining the ion-exchanged extrudate to obtain a catalyst material.

The green catalyst extrudate can optionally be dried to remove water before the pre-calcining step.

The mixing step can further comprise one or more precursors of one or more base metals, which can be for instance W or Mo, or a mixture of both. Additionally or alternatively, the mixing step can further comprise one or more precursors of one or more noble metals, which can be Pt or Pd, or a mixture of both.

Thus, in some implementations of the method, the method comprises mixing a binder, a porous crystalline material, water, and one or more precursors of base metal combinations of a first metal that is Ni or Co and a second metal that is Mo or W, or a mixture of these, to form an extrudable paste;
extruding the paste to form a green catalyst extrudate, drying the green catalyst extrudate to remove water, and pre-calcining the green catalyst extrudate in a nitrogen atmosphere to form a pre-calcined extrudate catalyst material;
ion-exchanging the pre-calcined extrudate to obtain an ion-exchanged extrudate; and
calcining the ion-exchanged extrudate to obtain a catalyst material.

In any implementation of the method, the base metal or noble metal precursor(s) can be a solution of a nitrate salt of the metal, a carbonate salt of the metal, a chloride salt of the metal, an acetate salt of the metal, or an ammonium salt of an oxide of the metal, or a mixture of any two or more of them. For example, a metal precursor can be a solution of ammonium heptmolybdate or ammonium tungstate.

In any implementation of the disclosed methods, the porous, crystalline material can be a zeolite, such as ZSM-48, ZSM-5, ZSM-11, ZSM-22, ZSM-23, ZSM-35, ZSM-50, ZSM-57, ZSM-58, zeolite beta, mordenite, MCM-68, a MCM-22 family material, or MCM-41, or a mixture of two or more thereof. A MCM-22 family material can be MCM-22, PSH-3, SSZ-25, MCM-36, MCM-49, MCM-56, ERB-1, EMM-10, EMM-10-P, EMM-12, EMM-13, UZM-8, UZM-8HS, ITQ-1, ITQ-2 or ITQ-30, or a mixture of two or more thereof.

In any implementation of the disclosed methods, the base metal precursor can be a solution of a nitrate salt of the base metal, a carbonate salt of the base metal, a chloride salt of the base metal, an acetate salt of the base metal, or an ammonium salt of an oxide of the base metal, or a mixture of any two or more of them.

In any implementation of the disclosed methods, the ion-exchanging step can be performed using an ammonium nitrate solution, an ammonium chloride solution, an ammonium carbonate solution or an ammonium acetate solution to form an ammonium-exchanged catalyst material.

In any implementation of the disclosed methods, the binder can be an alumina binder, a silica binder, a titania binder, a ceria binder, or a zirconia binder, or a mixture of any two or more of them. A binder used in the disclosed methods can be, for example, an alumina binder is one having a pseudoboehmite microstructure.

In any implementation of the disclosed methods, the binder can comprise a dopant, for example, magnesia or phosphorus or lanthanum.

Another aspect of the present disclosure lies in catalysts prepared by the method described herein. Such catalysts can be those in which the calcined extrudate catalyst material contains 0.05-60% total base metals, for example from 0.2-40%, or 1-40%, or 5-40%, or 1-30%, or 3-30%, or 5-30%, or from 1-20% or from 1-10%, of total base metals, one or more porous, crystalline materials in an amount of 1% to 99%, for example from 1-80%, 1-70%, 5-70%, 5-40% or 10-40% of porous crystalline material, and the balance of the weight is binder.

In such aspects, a catalyst disclosed herein can be one in which the base metals are Ni or Co and W or Mo, and the catalyst contains 0.05-20% Ni and 0.5-20% W or the catalyst contains 0.05-20% Ni and 0.5-20% Mo or the catalyst contains 0.05-20% Co and 0.0-20% Mo.

For example, a catalyst disclosed herein can be one in which the base metals are W or Mo and Ni, and the catalyst contains 0.8-5.0% Ni/3.0-15.0% W, or from 1.0-5.0% Ni/3.0-15.0% W, or from 1.0-5.0% Ni/3.0-15.0% Mo. In some implementations, the catalyst might contain 0.8-1.8% Ni/5.1-6.1% W or from 1.5-2.5% Ni/6.0-7.0% Mo.

Additionally or alternatively, a catalyst disclosed herein can be one in which the binder is an alumina binder, a silica binder, a titania binder, a ceria binder, or a zirconia binder, or a mixture of any two or more of them. In instances where an aluminum binder is present, the alumina binder can be one having a pseudoboehmite microstructure.

A binder used in a catalyst disclosed herein can further comprise a dopant, for example magnesia, phosphorus or lanthanum.

A catalyst as disclosed herein can be one that has a surface area >100 m²/gm, >120 m²/gm, >150 m²/gm or >200 m²/gm.

Yet another aspect of the present disclosure is a method for dewaxing a hydrocarbon feedstock comprising contacting the hydrocarbon feedstock with a catalyst that is disclosed herein.

The presently disclosed method provides catalysts in which the active metals across the cross-section of the catalyst pieces are evenly distributed throughout the entirety of the cross-section. This result may be contrasted with the “eggshell” distribution result typically observed when the metals are added to the catalyst by the prior art impregnation method, in which the great majority of the metal forms a relatively thin layer at the edge of the cross-section. The thickness of this edge of higher metal concentration of course depends on the particulars of the solution used to impregnate the metal e.g. the particular metal precursors used, the concentration of the metal precursors, the porosity of the catalyst extrudate being impregnated, and the like. Generally, the “shell” has a profile of metal concentration such that the highest metal concentration is at the surface of the catalyst and declining metal concentration along a radial line from the surface to the center of the catalyst. Typically the metal concentration declines exponentially along such a radial line.

The methods disclosed herein provide high performance, high quality catalysts having improvements in one or more of crush strength, reduction of loading density, micro-pore surface area, and uniformity of metal dispersion in comparison with similar catalysts prepared by the solution impregnation method. The working examples demonstrate that high performance and quality base metal-containing zeolite catalysts can be prepared by the muller addition method without a costly metal impregnation step. Example catalysts formulated with a high surface area binder and prepared by muller addition processes demonstrate improvements in crush strength, reduction of loading density, micro-pore surface area, and uniformity of metal dispersion.

Ion-exchanging pre-calcined extrudates in nitrogen is demonstrated in ammonium nitrate, ammonium acetate, or ammonium chloride solutions at ambient conditions.

The methods disclosed herein provide potential production cost reduction could be achieved by eliminating a costly metal impregnation process used in the prior art.

TPR testing of catalysts prepared as the examples described below demonstrates that catalysts prepared by the “muller addition” process disclosed show nearly equivalent or better HDS/HDN/Dewaxing activity than catalysts prepared metal impregnation process used in the prior art. Example catalysts containing 1.3% Ni/5.6% W and 2.0% Ni/6.5% Mo showed equivalent or better performance in all tests.

Catalysts prepared using the “muller addition” methods disclosed herein provide catalysts having a lower concentration of metals than reference sample (Example 1), yet having equivalent or better HDS/HDN/Dewaxing activities. So, the presently disclosed methods can provide better utilization of metals compared to methods using a solution impregnation method for introducing metals. Without being bound by any theory of the invention, it is suggested that the improvement might be due to more uniform distribution of metals and higher pore volumes in the finished catalysts.

HDS/HDN performance normalized to loaded metals content can be 2-3× greater, or more, in catalysts prepared by the presently disclosed methods than in catalysts prepared by post-extrusion impregnation. Overall, decreasing metals loading provides opportunity for lower manufacturing cost due to lower metals requirement for equivalent performance.

Loading densities of catalysts incorporating metals by the presently disclosed “muller addition” method can be at least ⅓ lower, and even lower, than the loading density that is used for a catalyst prepared by the solution impregnation method (e.g., the reference catalyst in Example 1). This can provide an advantage of lower weight of catalyst needed to achieve equivalent performance in commercial units and so lowered total catalyst cost. Activity of the example catalysts described below, normalized to loaded catalysts samples is >33% higher than for the reference sample (Example 1).

Overall activity, normalized for lower loaded metals and lower density, of catalysts prepared by the “muller addition” disclosed herein can be >6× higher, or >8× higher, or >10× higher, than catalysts prepared using post-extrusion solution impregnation methods.

The invention will now be more particularly described with reference to the following non-limiting Examples and the accompanying drawings.

### Example 1 (Reference Catalyst): 3 wt. % Ni and 15 wt. % W

65 parts (basis: calcined 538° C.) of ZSM-48 crystal were mixed with 35 parts of alumina binder (basis: calcined 538° C.) in a muller. Sufficient water was added to produce an extrudable paste. The paste composed of ZSM-48, alumina binder, and water was extruded and dried. The dried extrudate was calcined in nitrogen at 538° C. to decompose and remove the organic template. The N₂-calcined extrudate was humidified with saturated air and exchanged with 1 N ammonium nitrate to remove sodium. After ammonium nitrate exchange, the extrudate was washed with deionized water to remove residual nitrate ions prior to drying. The ammonium exchanged extrudate was dried at 121° C. and then calcined in air at 538° C. After air calcination, the catalysts were impregnated by incipient wetness with aqueous solutions of nickel nitrate and ammonium metatungstate hydrate to a target of ˜3 wt. % Ni and ˜15 wt. % W. Post metals impregnation, catalyst was air dried at 120° C. and air calcined in air at 538° C. Properties of the resulting catalyst are shown in Table 1.

### Example 2: Preparation of Catalysts with ⅕ wt % of Ni/W with Muller Addition of Metal Precursors

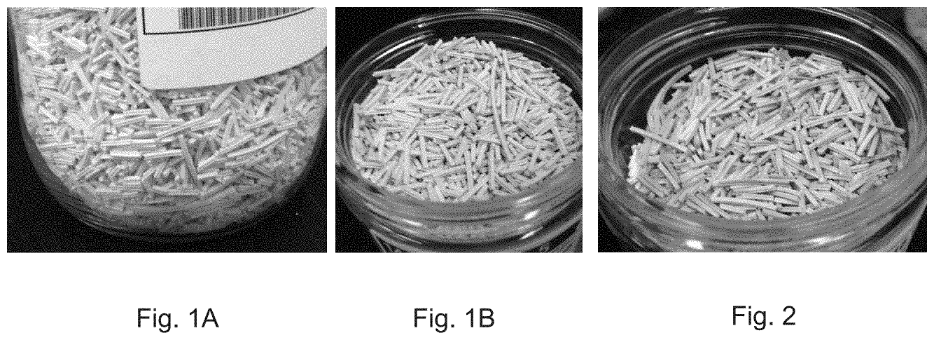

65 parts (basis: calcined 538° C.) of ZSM-48 crystal were mixed with 35 parts of pseudoboehmite alumina of Versal™ 300 (basis: calcined 538° C.) and base metals precursors (Nickel Nitrate Hexahydrate and Ammonium Metatungstate Hydrate solutions) in a Simpson muller. Sufficient water was added to produce an extrudable paste on an extruder. The mix of ZSM-48, pseudoboehmite alumina, metal precursor, and water containing paste was extruded and dried in a hotpack oven at 121° C. overnight, see FIG. 1A. The dried extrudate was calcined in nitrogen at 538° C. to decompose and remove the organic template. The N₂ calcined extrudate was humidified with saturated air and exchanged with 1 N ammonium nitrate to remove sodium (spec: <500 ppm Na). After ammonium nitrate exchange, the extrudate was washed with deionized water to remove residual nitrate ions prior to drying. The ammonium exchanged extrudate was dried at 121° C. overnight and calcined in air at 538° C., see FIG. 1B. Properties of the resulting catalyst are shown in Table 1.

### Example 3: Example 2: Preparation of Catalysts with 2/10 wt % of Ni/W with Muller Addition of Metal Precursors

65 parts (basis: calcined 538° C.) of ZSM-48 crystal were mixed with 35 parts of pseudoboehmite alumina of Versal™ 300 (basis: calcined 538° C.) and base metals precursors (nickel nitrate hexahydrate and ammonium metatungstate hydrate solutions) in a Simpson muller. Sufficient water was added to produce an extrudable paste on an extruder. The mix of ZSM-48, pseudoboehmite alumina, metal precursor, and water containing paste was extruded and dried in a hotpack oven at 121° C. overnight. The dried extrudate was calcined in nitrogen at 538° C. to decompose and remove the organic template. The N₂ calcined extrudate was humidified with saturated air and exchanged with 1 N ammonium nitrate to remove sodium (spec: <500 ppm Na). After ammonium nitrate exchange, the extrudate was washed with deionized water to remove residual nitrate ions prior to drying. The ammonium exchanged extrudate was dried at 121° C. overnight and calcined in air at 538° C., see FIG. 2. Properties of the resulting catalyst are shown in Table 1.

### Example 4: Preparation of Catalysts with 2/15 wt % of Ni/W with Muller Addition of Metal Precursors

65 parts (basis: calcined 538° C.) of ZSM-48 crystal were mixed with 35 parts of pseudoboehmite alumina of Versal™ 300 (basis: calcined 538° C.) and base metals precursors (nickel nitrate hexahydrate and ammonium metatungstate hydrate solutions) in a Simpson muller. Sufficient water was added to produce an extrudable paste on an extruder. The mix of ZSM-48, pseudoboehmite alumina, metal precursor, and water containing paste was extruded and dried in a hotpack oven at 121° C. overnight. The dried extrudate was calcined in nitrogen at 538° C. to decompose and remove the organic template. The N₂ calcined extrudate was humidified with saturated air and exchanged with 1 N ammonium nitrate to remove sodium (spec: <500 ppm Na). After ammonium nitrate exchange, the extrudate was washed with deionized water to remove residual nitrate ions prior to drying. The ammonium exchanged extrudate was dried at 121° C. overnight and calcined in air at 538° C. Properties of the resulting catalyst are shown in Table 1.

### Examples 5(5A, 5B, & 5C): Preparation of Catalysts with 2/6 wt % of Ni/Mo with Muller Addition of Metal Precursors

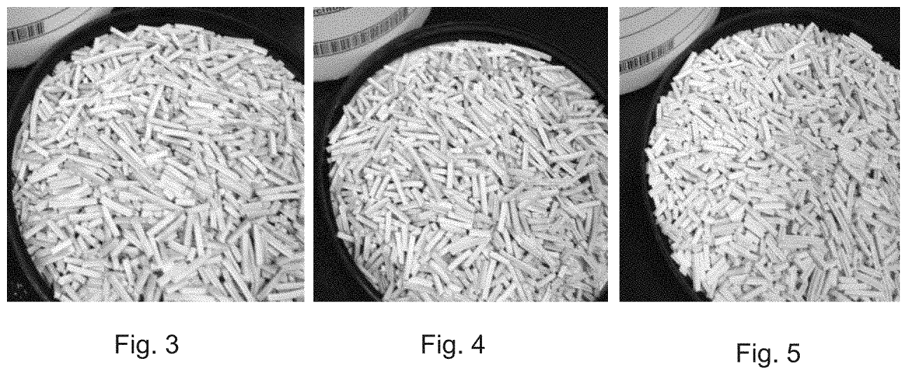

65 parts (basis: calcined 538° C.) of ZSM-48 crystal were mixed with 35 parts of pseudoboehmite alumina of Versal™ 300 (basis: calcined 538° C.) and base metals precursors (nickel nitrate hexahydrate and ammonium heptmolybdate solutions) in a Simpson muller. Sufficient water was added to produce an extrudable paste on an extruder. The mix of ZSM-48, pseudoboehmite alumina, metal precursor, and water containing paste was extruded and dried in a hotpack oven at 121° C. overnight. The dried extrudate was calcined in nitrogen at 538° C. to decompose and remove the organic template. The N₂ calcined extrudate was humidified with saturated air and exchanged with 1 N ammonium nitrate, or ammonium acetate, or ammonium chloride to remove sodium (spec: <500 ppm Na). After exchanging, the extrudate was washed with deionized water to remove residual nitrate ions prior to drying. The ammonium exchanged extrudate was dried at 121° C. overnight and calcined in air at 538° C. Properties of the resulting catalysts, 5A (ammonium nitrate—shown in FIG. 4), 5B (ammonium acetate—shown in FIG. 3), & (ammonium chloride) are shown in Table 1.

### Example 6: Preparation of Catalysts with ⅕ wt % of Ni/Mo with Muller Addition of Metal Precursors

65 parts (basis: calcined 538° C.) of ZSM-48 crystal were mixed with 35 parts of pseudoboehmite alumina of Versal™ 300 (basis: calcined 538° C.) and base metals precursors (nickel nitrate hexahydrate and ammonium heptmolybdate solutions) in a Simpson muller. Sufficient water was added to produce an extrudable paste on an extruder. The mix of ZSM-48, pseudoboehmite alumina, metal precursor, and water containing paste was extruded and dried in a hotpack oven at 121° C. overnight. The dried extrudate was calcined in nitrogen at 538° C. to decompose and remove the organic template. The N₂ calcined extrudate was humidified with saturated air and exchanged with 1 N ammonium nitrate to remove sodium (spec: <500 ppm Na). After ammonium nitrate exchange, the extrudate was washed with deionized water to remove residual nitrate ions prior to drying. The ammonium exchanged extrudate was dried at 121° C. overnight and calcined in air at 538° C., see FIG. 5. Properties of the resulting catalyst are shown in Table 1.

TABLE 1
Properties of Finished Catalysts

| | | | Total | Micro + | | W or Mo |
|---|---|---|---|---|---|---|
| | Alpha | Hexane | SA | meso SA | Ni % | % |
| Example 1, | 23 | 16 | 129 | 40/89 | 2.6 | 14(W) |
| Reference | | | | | | |
| Example 2 | 37 | 41.5 | 316 | 86/230 | 1.35 | 5.62(W) |
| Example 3 | 48 | 46.3 | 302 | 81/221 | 2.1 | 9.2(W) |
| Example 4 | 37 | 38.5 | 261 | 68/193 | 1.8 | 17.4(W) |
| Example 5A | 28 | 46.3 | 337 | 83/254 | 2 | 6.5(Mo) |
| Example 5B | 26 | 45.2 | 334 | 81/253 | 2.2 | 6.06(Mo) |
| Example 5C | 23 | 47.6 | 257 | 68/189 | 2.1 | 7.06(Mo) |
| Example 6 | 41 | 48.5 | 345 | 92/253 | 1.1 | 3.1(Mo) |

### Example 7: Energy-Dispersive X-Ray Spectroscopy Mapping of Metal Distribution Across Catalyst Cross-Section

The distribution of metals across the cross-section of pieces of a Nickel Alumina catalyst comprising 2% Ni and 10% W was assessed by energy-dispersive X-ray spectroscopy mapping. Cut cross-section surfaces of 5 pieces of the catalyst prepared in Example 4 were examined at different resolutions.

All samples were mounted in a 1¼″ mount with LR white epoxy. The cut cross-section surface was polished wet with diamond disks to 8 um, then polished wet with 6, 3, and 1 um diamond solution and finally coated with carbon.

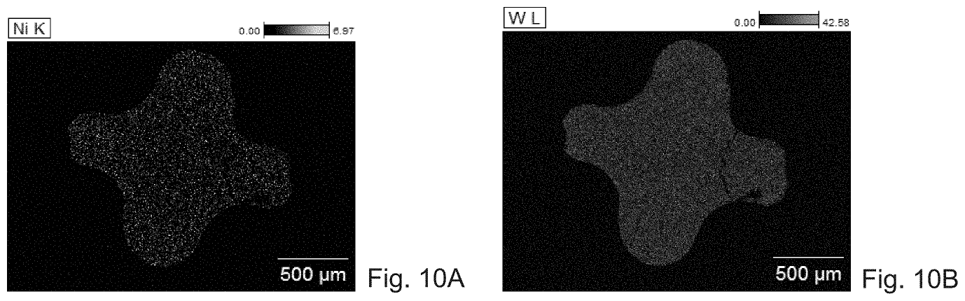

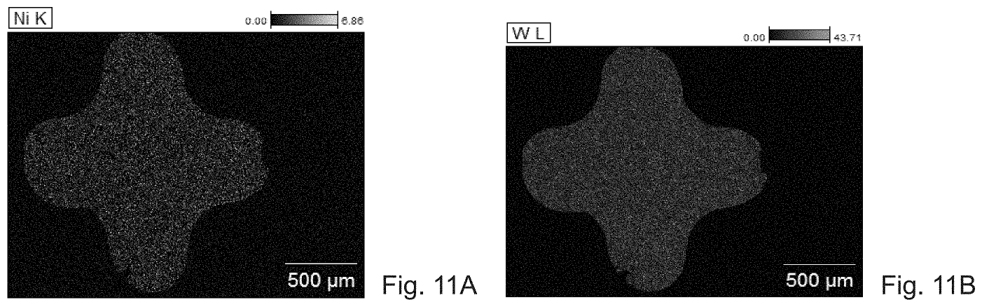

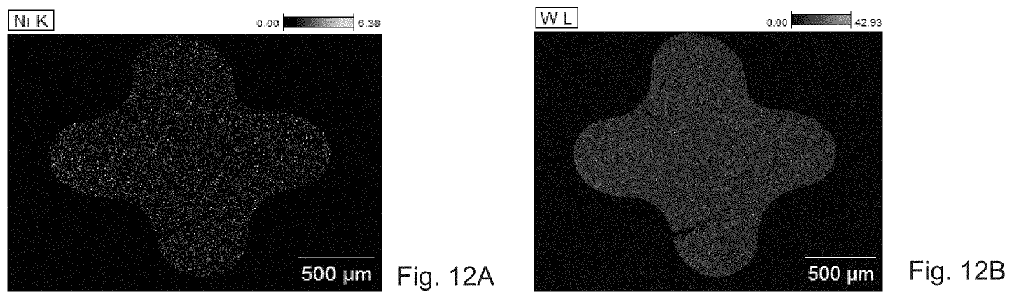

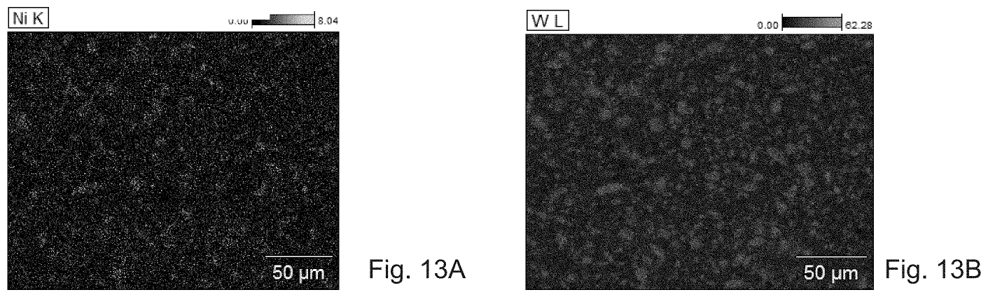

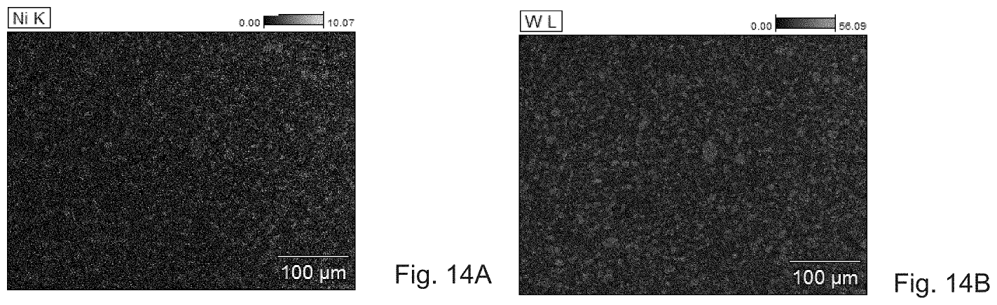

Images are presented as FIGS. 10A-14B. The EDS mapping of the metals across the cross-section of the catalyst pieces shows that the metals are evenly distributed throughout the entirety of the cross-section.

### Example 8: Catalytic Performance of Exemplary Catalyst Preparations

The performance of catalyst samples prepared by the “muller addition” of metals method (Examples 2-5) were compared against incipient-wetness impregnated Ni/W catalyst (Example 1) in a tri-phase reactor (TPR). Catalytic performance evaluation included: HDS, HDN, and dewaxing activity testing. Two feeds were used in the test: a refinery high-pressure hydrotreating diesel unit feed and a high-pressure hydrotreater diesel product (ULSD) spiked with dimethyl-disulfide (DMDS) and tertbutyl amine (TBA). A summary of key feed properties is provided in Table 2.

TABLE 2
Summary of feed properties used in the catalytic testing.

| | HPHT | Spiked HPHT |
|---|---|---|
| Description | Diesel Unit Feed | Diesel Unit Product |
| S, wt. % | 1.03 | 1.43 |
| N, wppm | 461 | 472 |
| API Gravity | 28.7 | 33.9 |
| Cloud Point, ° C. | 13.0 | −2.5 |
| GCD, ° F. | | |
| Initial Boiling Point | 297 | 215 |
| 5 wt. % | 419 | 366 |
| 10 wt. % | 480 | 417 |
| 20 wt. % | 541 | 473 |
| 30 wt. % | 591 | 512 |
| 40 wt. % | 635 | 543 |
| 50 wt. % | 672 | 570 |
| 60 wt. % | 696 | 596 |
| 70 wt. % | 716 | 626 |
| 80 wt. % | 739 | 655 |
| 90 wt. % | 770 | 691 |
| Final Boiling Point | 853 | 786 |

Catalyst densities were measured with small quantities of extrudates. The densities were further used to calculate weights of 14/25 mesh sized catalysts representative of 1.5 cc of unsized extrudates. Loaded quantities are listed in Table 3.

TABLE 3
Catalyst sizing for TPR unit catalytic testing. Actual
mass represent mass loaded into the unit. Catalyst densities
were sized using small volumes of whole extrudates. The
loaded catalysts were sized to mesh 14/25.

| | | Desired | | |
|---|---|---|---|---|
| | | vol to | Desired | Loaded |
| | Density | load | mass | mass |
| Catalyst | (g/cc) | (cc) | (g) | (g) |
| Example 1: 2.9% Ni-15.4% W- | 0.832 | 1.5 | 1.248 | 1.25 |
| ZSM-48/V300 (traditional impreg) | | | | |
| Example 2: 1.3% Ni-5.6% W- | 0.476 | 1.5 | 0.713 | 0.71 |
| ZSM-48/V300 (muller impreg) | | | | |
| Example 3: 2.1% Ni-9.1% W- | 0.511 | 1.5 | 0.766 | 0.77 |
| ZSM-48/V300 (muller impreg) | | | | |
| Example 4: 1.8% Ni-17.4% W- | 0.534 | 1.5 | 0.801 | 0.80 |
| ZSM-48/V300 (muller impreg) | | | | |
| Example 5: 2.0% Ni-6.5% Mo- | 0.482 | 1.5 | 0.724 | 0.72 |
| ZSM-48/V300 (muller impreg) | | | | |

The general conditions for TPR testing were a feed rate of 2.0 LHSV, operating pressure of 1000 psig, 2,250 SCFB. Catalyst performance was tested on two feeds.

HDS/HDN performance of base metals was evaluated for 21 days on a HPHT feed comprising ˜1 wt. % organic S, ˜450 ppm organic N. Temperature holds were imposed at 650° F. (2×), 680° F., 690° F., 700° F. and 720° F.

Dewaxing performance of ZSM-48 was evaluated for 8 days on spiked HPHT product comprising ˜1.5 wt. % S (as DMDS), ˜500 ppm N (as TBA); DMDS and TBA decompose to H₂S and NH₃ to simulate bottom of HDT. Temperature holds were imposed at 680° F. and 720° F.

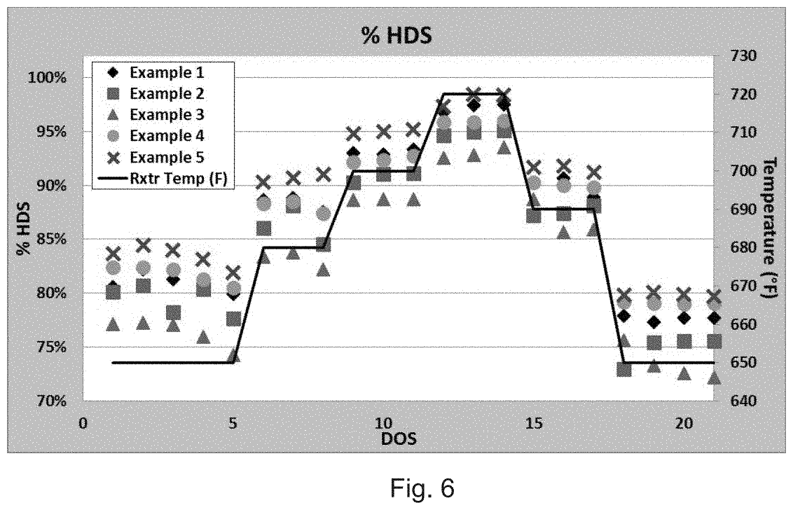

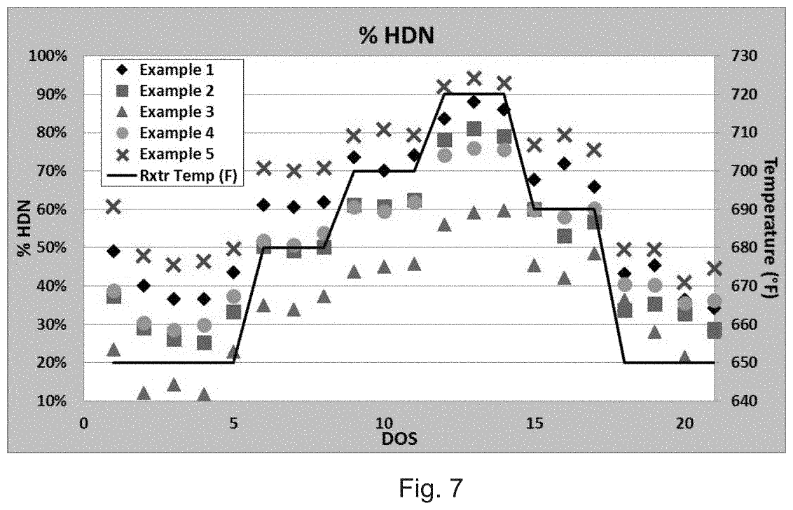

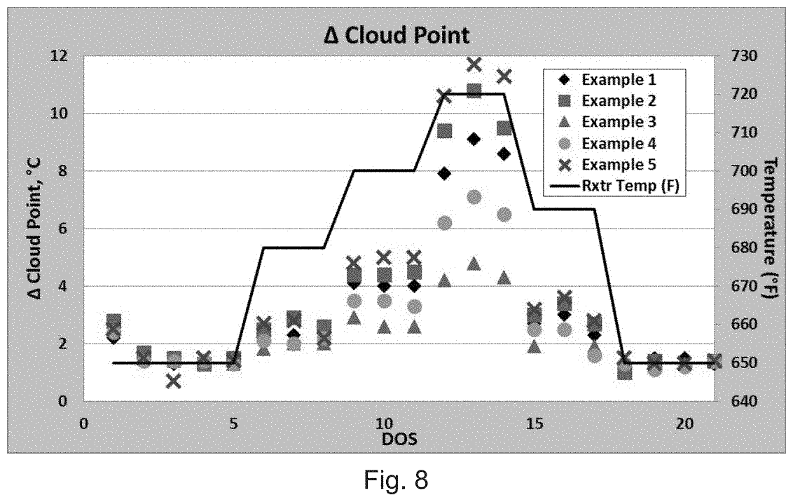

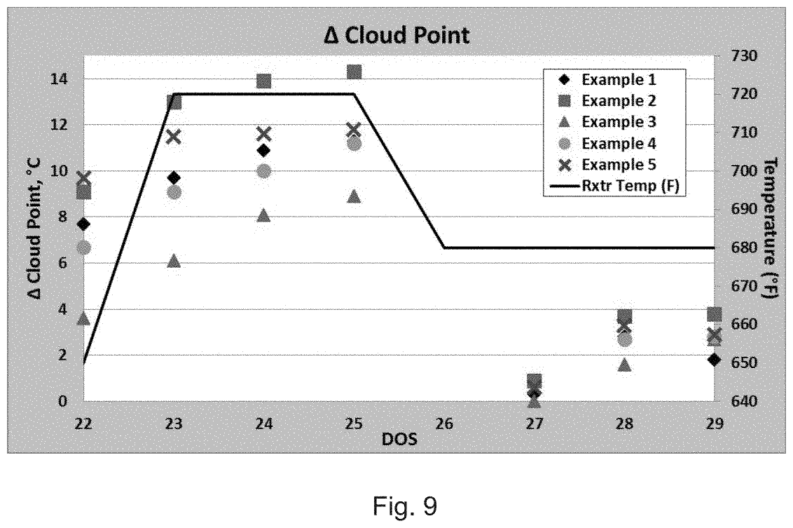

Results of the tests are shown in FIGS. 6-9.

The description in this application is intended to be illustrative and not limiting of the invention. One in the skill of the art will recognize that variation in materials and methods used in the invention and variation of embodiments of the invention described herein are possible without departing from the invention. It is to be understood that some embodiments of the invention might not exhibit all of the advantages of the invention or achieve every object of the invention. The scope of the invention is defined solely by the claims following.

1. A method for producing a catalyst material comprising:
mixing a binder, a porous crystalline material, water, and one or more precursors of a first base metal that is Ni or Co or a mixture of these, and one or more precursors of a second base metal that is Mo or W, or a mixture of these, to form an extrudable paste;
extruding the paste to form a green catalyst extrudate, drying the green catalyst extrudate to remove water, and pre-calcining the green catalyst extrudate in a nitrogen atmosphere to form a pre-calcined extrudate catalyst material;
ion-exchanging the pre-calcined extrudate to obtain an ion-exchanged extrudate; and
calcining the ion-exchanged extrudate to obtain a catalyst material.

2. The method of claim 1, in which the mixing step further comprises one or more precursors of one or more noble metals Pt or Pd, or a mixture of both.

3. The method of claim 1, in which the porous crystalline material is ZSM-48, ZSM-5, ZSM-11, ZSM-22, ZSM-23, ZSM-35, ZSM-50, ZSM-57, ZSM-58, zeolite beta, mordenite, MCM-68, a MCM-22 family material, or MCM-41, or a mixture of two or more thereof.

4. The method of claim 2, in which the porous crystalline material is ZSM-48, ZSM-5, ZSM-11, ZSM-22, ZSM-23, ZSM-35, ZSM-50, ZSM-57, ZSM-58, zeolite beta, mordenite, MCM-68, a MCM-22 family material, or MCM-41, or a mixture of two or more thereof.

5. The method of claim 3, in which the MCM-22 family material is MCM-22, PSH-3, SSZ-25, MCM-36, MCM-49, MCM-56, ERB-1, EMM-10, EMM-10-P, EMM-12, EMM-13, UZM-8, UZM-8HS, ITQ-1, ITQ-2 or ITQ-30, or a mixture of two or more thereof.

6. The method of claim 4, in which the MCM-22 family material is MCM-22, PSH-3, SSZ-25, MCM-36, MCM-49, MCM-56, ERB-1, EMM-10, EMM-10-P, EMM-12, EMM-13, UZM-8, UZM-8HS, ITQ-1, ITQ-2 or ITQ-30, or a mixture of two or more thereof.

7. The method of claim 1, in which the base metal precursor is a solution of a nitrate salt of the base metal, a carbonate salt of the base metal, a chloride salt of the base metal, an acetate salt of the base metal, or an ammonium salt of an oxide of the base metal, or a mixture of any two or more of them.

8. The method of claim 1, in which at least one base metal precursor is a solution of ammonium heptamolybdate or ammonium tungstate.

9. The method of claim 2, in which at least one base metal precursor is a solution of ammonium heptamolybdate or ammonium tungstate.

10. The method of claim 1, in which the ion-exchanging step is performed using an ammonium nitrate solution or an ammonium chloride or an ammonium carbonate or an ammonium acetate solution to form an ammonium-exchanged catalyst material.

11. The method of claim 1, in which the binder is an alumina binder, a silica binder, a titania binder, a ceria binder, or a zirconia binder, or a mixture of any two or more of them.

12. The method of claim 11 in which the alumina binder is one having a pseudoboehmite microstructure.

13. The method of claim 11, in which the binder further comprises a dopant.

14. The method of claim 13, in which the dopant is magnesia or phosphorus or lanthanum.

15. A catalyst prepared by the method of claim 1, in which the calcined extrudate catalyst material contains 0.05-60% total base metals, a zeolite or mixtures thereof in an amount of 1% to 99%, and the balance of the weight is binder.

16. The catalyst of claim 15, in which the base metals are Ni or Co and W or Mo, and the catalyst contains 0.05-20% Ni and 0.5-20% W or the catalyst contains 0.05-20% Ni and 0.5-20% Mo or the catalyst contains 0.05-20% Co and 0.0-20% Mo.

17. The catalyst of claim 15, in which the base metals are W or Mo and Ni, and the catalyst contains 1.0-5.0% Ni/3.0-15.0% W or from 1.0-5.0% Ni/3.0-15.0% Mo.

18. A method for dewaxing a hydrocarbon feedstock comprising contacting the hydrocarbon feedstock with a catalyst of claim 15.
